(19) United States
(12) Patent Application Publication
(10) Pub. No.: US 2015/0019873 A1
(43) Pub. Date: Jan. 15, 2015

(54) SYSTEM FOR EMBEDDED BIOMETRIC AUTHENTICATION, IDENTIFICATION AND DIFFERENTIATION

(71) Applicant: HGN Holdings, LLC, Dallas, TX (US)

(72) Inventor: ANDREW HAGEMANN, Plano, TX (US)

(21) Appl. No.: 13/942,059

(22) Filed: Jul. 15, 2013

(51) Int. Cl. H04L 29/06

(52) U.S. Cl. CPC H04L 63/0861
USPC 713/186

(57) ABSTRACT

An electronic device authenticates a user without requiring active input from the user. At least one user interface receives a plurality of user inputs to the electronic device that are unrelated to an active authentication action of the user of the electronic device. At least one biometric sensor extracts from the plurality of user inputs, biometric data identifying the user. A processor authenticates the user responsive to the extracted biometric data.

### CROSS-REFERENCE TO RELATED APPLICATIONS

This application claims priority to U.S. Provisional Application No. 61/701,564, filed on Sep. 14, 2012, which is incorporated herein by reference.

### TECHNICAL FIELD

This disclosure relates generally to biometric authentication systems, and more specifically to those that can be implemented in electronic devices such as smartphones, tablets, computers and other embodiments of smart-glass and touch-surfaces such as vehicles.

### BACKGROUND

Traditional authentication for electronic devices generally consists of a username and a password, challenge questions, personal identification numbers (PINs) or similar methods that require active authentication and recollection of such information. Due to the inconvenience imposed on users by these methods, lack of use is not uncommon. If these methods are employed, they may be undermined by a poorly chosen password. In general, as the strength of the security is increased, so too, does the complexity, inconvenience, and voluntary rate of avoiding implementation of such protocols.

Mobile computing, whether by smartphone, tablet, laptop, or any other like device, continues to proliferate as computing power and wireless data speeds increase. Capable of performing and outperforming the same functions, these platforms are seeing adoption as a replacement for functions of previously less-mobile and stationary devices. Problems arise when mobile devices store sensitive data as such devices are prone to increased loss and theft due to their size and portability. The increase in risk by these adoption patterns needs to be addressed with an increase in security, which, like these devices, is more convenient and powerful.

In response to some of these issues, biometric data has seen limited incorporation into systems of security on mobile devices, most commonly in the form of fingerprint or thumbprint scanners. Scanners, in the case of prints, may utilize capacitance, optical, ultrasonic, or other methods of mapping these biometric data points which are subsequently compared to that of authorized users.

A benefit of these systems is that each individual generally possesses unique biometric characteristics, such as fingerprints, retinal patterns, vein patterns, brain waves, DNA and the like. Biometrics hereinafter should be interpreted to include any such unique identifying information. By these properties, biometric data points may serve as a unique identifier or a password substitute. Despite the obvious benefits of such methods, many implementations still require active authentication despite eliminating the onerous task of remembering passwords. An improved method of authentication and identification would involve pervasive installation of biometric gathering means and a method by which said biometric data would be collected in a continuous fashion with authentication occurring automatically in the background.

The methods for determining ownership of electronic products also have not advanced substantially to match convenience and ease of use desired by users. Vehicles are one area in which there has not been any significant change beyond the development of smart-keys. While these newer keyless-entry systems are an improvement over vehicles that require a key to be inserted in an ignition, they still require a physical key and do not identify a user beyond the possession of said easily stolen or lost key.

An authentication method that requires a specific identity to be established to start a vehicle, as opposed to, or including, possessing a key would prevent vehicle theft if a key is stolen. Such a system may include the embodiment of biometric sensors on a window, door handle, steering wheel, or similar area where contact is common.

In other devices, security may not be a primary concern; however, in these cases, biometric authentication may be of use in soft-security for differentiation and implementing settings. Many electronic devices have multiple users; but, differentiation of the users may not include or not need to include authentication. In vehicles, as opposed to the ability of entry or driving, settings and preferences may require only identification which may not necessitate protocols as stringent as those for authentication. Contact with vehicle embedded biometrics may allow for automatic implementation of settings and preferences for a user.

An alternate system through, its own wireless connection, or that of a third-party device as a proxy, could send biometric data out and receive settings back for implementation. In this case, implementation of settings would be available across connected cars or in cars with the appropriate software via a mobile device. With this connection, preferences would be loaded automatically in any such vehicle for a driver or a passenger. These settings could be implemented in different models, makes, and classes of vehicle, wherein said settings would be altered for disparate vehicles due to differences thereof.

Among the proliferation of electronic devices, a common problem has become mixups between similar or identical products. A soft-security biometric approach may be used to differentiate these devices and appraise the owner of their device.

### SUMMARY

The present invention, as disclosed and described herein, comprises an electronic device that authenticates a user without requiring active input from the user. At least one user interface receives a plurality of user inputs to the electronic device that are unrelated to an active authentication action of the user of the electronic device. At least one biometric sensor extracts from the plurality of user inputs, biometric data identifying the user. A processor authenticates the user responsive to the extracted biometric data.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 illustrates an electronic device for use with an autonomous biometric authentication system in accordance with one embodiment of the invention;

FIG. 2 is a block diagram of illustrative communication processes between an electronic device and an additional electronic device;

FIG. 3 is a block diagram of an illustrative electronic device for use with an autonomous biometric authentication system in accordance with one embodiment of the invention;

FIG. 4 is a flow chart of an illustrative process for authenticating a user in accordance with one embodiment of the invention;

FIG. 5 is a flow chart of an illustrative process for authenticating a user in accordance with one embodiment of the invention;

FIG. 6 is a flow chart of an illustrative process for authenticating a user and loading settings and data in accordance with one embodiment of the invention;

FIG. 7 is a flow chart of an illustrative process for differentiating electronic devices in accordance with one embodiment of the invention;

FIG. 8 is a flow chart of an illustrative process for authenticating a user in accordance with one embodiment of the invention;

FIG. 9 illustrates a use of remote storage and processing;

FIG. 10 illustrates a single device using multiple user settings;

FIG. 11 illustrates the system in a vehicle; and

FIG. 12 illustrates multiple devices controlling a single vehicle setting.

### DETAILED DESCRIPTION

An electronic device having a biometric authentication system for autonomously permitting and preventing access in its entirety, selectively, or conditionally is provided. Electronic devices, and devices which embody electronic devices, having biometric authentication and identification systems for autonomously permitting and preventing access or usage, and loading specific user settings, preferences, and limitations is provided. Authentication performed repeatedly and continuously, ad infinitum whereby a device re-authenticates a user automatically without active distinct user input. Continued authentication may be intervaled, random, or algorithmically predetermined and utilize a plurality of biometric data points over time including usage of each recorded data point.

Many biometric authentication systems are suitable implementations to accomplish continuous authentication. Data points of the same type as well as a plurality of data points from a plurality of sources may be used to achieve repeated authentications. In one embodiment, the device may utilize biometric data points likely to be generated by interaction with a touch interface such as fingerprints, thumbprints, and other like prints; venous or arterial blood vessel patterns; wrinkle lines; or any other surface or subcutaneous patterns. Other embodiments may include external aspects generally unique to an individual gathered by optical sensors such as a still camera or video camera. Such external characteristics may include retinas, eyes, facial characteristics, ear characteristics, ear canal characteristics, and other generally differentiating characteristics. Additional biometric data points may be comprised of characteristics regarding voice, typing and other inputs, gait, or DNA based measures.

An electronic device may incorporate any number of suitable biometric authentication systems to be used selectively or together to continuously authenticate a user. Different access levels, settings and usage may incorporate different embodiments with regard to authentication protocols and frequency of use thereof. These differentiations may have a default recommendation, be determined conditionally, or set by the user.

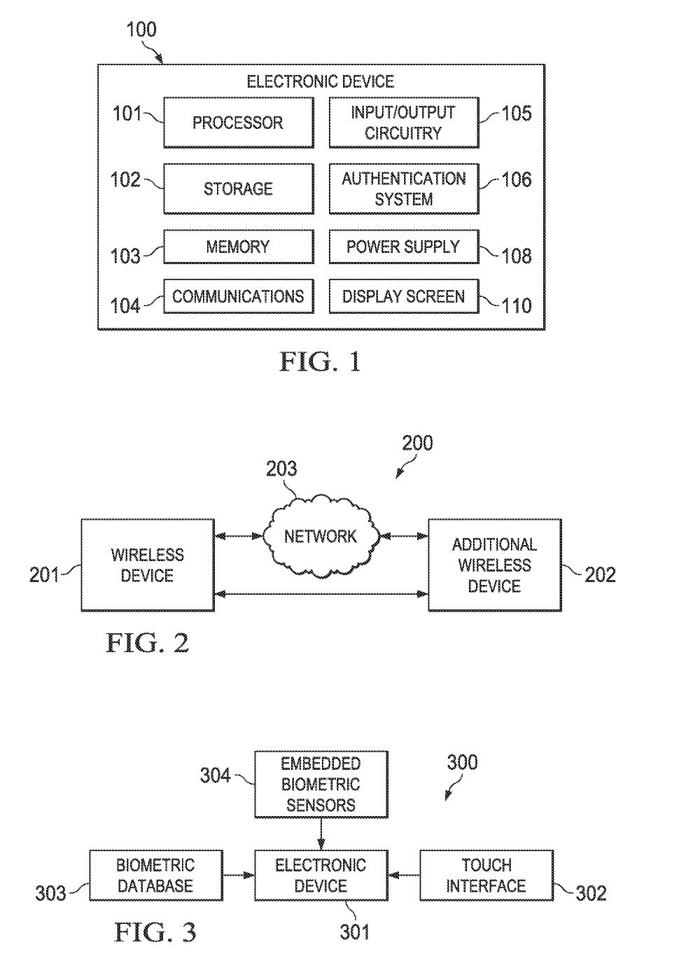

FIG. 1 is a view of an illustrative electronic device for use with an authentication system in accordance with one embodiment on the invention. An electronic device 100 for use with a biometric authentication system 106 in accordance with one embodiment of the invention. Electronic device 100 may include processor 101, storage 102, memory 103, communications 104, I/O (input/output) system 105, power supply 108, display circuitry 110, and authentication system 106. In some embodiments, one or more of the components of electronic device may be combined, integrated, omitted, or occur in plurality.

Processor 101 may include any necessary circuitry to control operations and performance of electronic device 100. For example, processor 101 may be used to run operating system applications, firmware applications, or software applications installed on electronic device. In some embodiments, processor 101 may drive control displays as well as other inputs and outputs from a user interface.

Storage 102 may include one, or a plurality, of storage mediums suitable for data storage in electronic device 100. Memory 103 may include one, or a plurality, of mediums suitable for short-term data storage in electronic device 100. In some embodiments, memory 103 and storage 102 may be integrated into a component suitable to perform the functions thereof

Communications 104 may include suitable circuitry such that electronic device 100 may exchange and communicate data with a plurality of other electronic devices, servers or other intermediate communications hardware, firmware or software. Electronic device 100 may include multiple instances of a single communication method or plurality of instances of multiple methods. In some embodiments, communications may occur simultaneously across multiple protocols, with multiple network connections being maintained.

Input/output circuitry 105 may include methods requisite to encoding and decoding non-digital information, such as analog signals, into digital data as well as vice versa. In some embodiments, such signals may include display visuals, touch-interactions, movement, location or audio signals. For instance, electronic device 100 may include any suitable mechanism or component such that a user may provide inputs to input/output circuitry 105. For example, touch-screen interactions, buttons, distinct movements, or unique combinations of inputs may be included in some embodiments.

In other embodiments input/output circuitry 105 may interact with other components to receive and send inputs and outputs. Electronic device 100 may use communications circuitry 104 with input/output circuitry 105 to send and receive data, signals, or other information to or from other electronic devices.

Display circuitry 110 may also include drivers and components to drive such drivers, whereby a display means necessary for displaying media, application output, and other information, or data that can be visually displayed.

Authentication system 106 includes any suitable means, system, sensors, or other implementations to receive, detect, or measure an input that may identify a user of electronic device 100. The inputs may comprise a single input, all inputs, randomly selected inputs or inputs selected according to a predetermined algorithm. Such identifying inputs may include optical, capacitance, or ultrasonic scanners for identifying fingerprints, thumbprints, and other surface skin-based patterns or data. Some embodiments may include mechanisms for measuring subcutaneous identifying patterns. Other embodiments may include a system capable of identifying a user by eyes, retinas, facial characteristics, or any other unique or identifying biometric features, characteristics, or attributes. In some embodiments, unique inputs from a user may function as an authentication system such as voice, interaction, movement, vibrations, or location. In some embodiments, authentication system 106 may be a plurality of systems embedded in electronic device 100 or other devices where independent systems communicate. Electronic device 100 may include circuitry such as a bus for data transfer between components.

Some embodiments may implement multiple authentication systems 106 to be completed sequentially to gain access to electronic device 100 or a specified sub-set of electronic device 100 access, data, or functionality thereof. For example, electronic device 100 may allow use of a phone function without authentication; but, require user identification and authentication before access to contact list data. In other embodiments, electronic device may require active user re-authentication after certain intervals of use or non-use, random prompts without regard to use or data access, or random prompts with varying levels of frequency based on use of functions or data access.

FIG. 2 is a block diagram of a wireless device 201 and its communication between an additional wireless device 202. Communication between 201 and 202 can occur via direct communication between the devices in one embodiment. While in other embodiments, communication between 201 and 202 may take place via an intermediary or a network 203 wherein communication is not direct. In any such embodiment of communication between 201 and 202, whether direct or indirect, an electronic device with wireless capabilities employs communications circuitry in accordance with 104 on FIG. 1.

FIG. 3 is a block diagram illustrating components of an autonomous biometric authentication system in accordance with one embodiment of the invention. Electronic device 301 may take input not intended for authentication and use input as an authentication measure, in addition to the original purpose of said input. Electronic device 301 may take an input to any suitable touch interface 302, whether that be capacitance, resistive, or other touch screen suitable for similar inputs where the purpose of the user interaction is to interact with electronic device 301. In one embodiment, a user input may be made to open an application, scroll a page, or execute any command via a touch screen interface 302. Electronic device 301 and system may additionally use the input to authenticate the user via a fingerprint in one embodiment, against a database of user biometrics 303. In another embodiment, other interactions with electronic device 301 may be taken by biometric sensors 304 other than those built into a touch interface 302.

In some embodiments, these dual use inputs may result in continuous authentication and re-authentication of a user as a background process. Electronic device 301 may use inputs for authentication system despite a different intent for the input by the original user. In a further embodiment, electronic device 301 may perform multiple authentications over time in the background for continual re-authentication and confirmation of user identity. For example, when making a phone call, a fingerprint may be gathered when the phone number is selected on a touch screen. During the phone call, the voice of the user may be analyzed, and physical facial characteristics may be gathered by a camera component proximate to the user. When user ends the call, electronic device 301 may gather retinal patterns when user views electronic device 301, and blood vessel patterns may be collected by contact with the device while it is held by user.

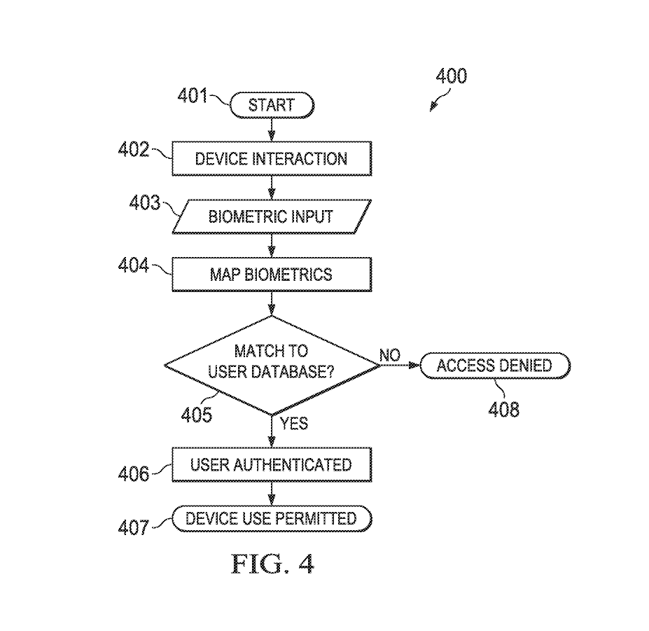

FIG. 4 is a flow chart of an illustrative process for authenticating the user of an electronic device in accordance with one embodiment of the invention. The user of an electronic device interacts with said device at step 402 in order to create an input for executing a planned function on behalf of the user, where the intent of the input is an interaction and not necessarily for the sole purpose of authentication. For example, a user may wish to activate the screen and push a physical device button, hold the electronic device, flip a switch, perform a screen unlocking action, or similar that requires proximity or contact with the electronic device. The electronic device gathers a biometric input at step 403 from the interaction as well as executes the intended function and maps the biometrics at step 404 into a digital format to be compared to a database of the user's stored biometrics. If the gathered input 403 and the mapped biometric data 404 match the user database at step 405, the user is authenticated at step 406 and the device is able to be used at step 407. However, if the inquiry step 405 does not result in a match, access to electronic device is denied at step 408.

In some embodiments the electronic device may connect to a remote location for processing all or a portion of authentication process at step 405. For example, a cloud server may receive fingerprints gathered by electronic device at step 403, where said biometric data is authenticated remotely, and the result of the process at step 405 is sent back to electronic device. In another implementation, electronic device may store a plurality of biometric data unique to a user on a remote database. Remote database may further incorporate a learning model or system where changes in biometric data are tracked and variation in measures over time are accounted for. The system may request new measures to confirm changes over time, based on drift, user age, or periodically. For instance, electronic device may gather measures regarding user gait for authentication. As user ages, such a measure may change over time; remote database may account for changes in biometrics against which authentication occurs such that a user does not inadvertently fail authentication.

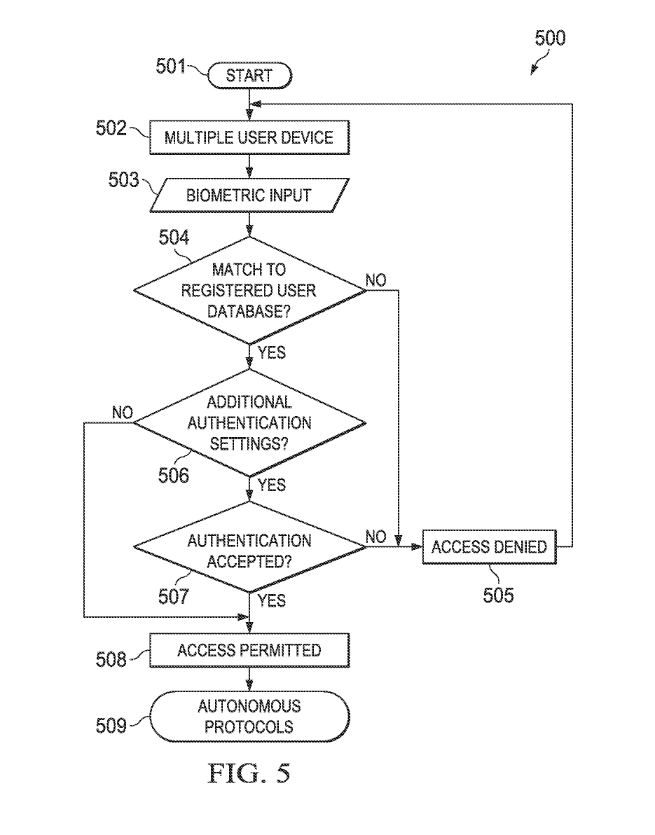

FIG. 5 is a flow chart of an illustrative process for authenticating the user of an electronic device in accordance with one embodiment of the invention. The electronic device in this embodiment has more than one user and interaction therewith may require different user access for each specific user or group of users. As with FIG. 4, a user may interact with multiple user electronic devices at step 502 such that the accessed device performs authentication without the intent of the user interaction being an authentication. In the example where a user presses a button with the intent and result being to activate a screen, or any such other device interaction, a biometric input is created at step 503. This input is compared to a database of registered users for that device at step 504. If the user is not found to match an entry within the database of registered users then no access is allowed at step 505. If the user is found to match an entry within the database, the electronic device may check if the user has elected to require additional authentication procedures at step 506, such as a passcode or similar. Should the user settings require an additional round of authentication at step 507 and this authentication is not accepted, the access is denied at step 505, though a certain number of tries may be a allowed. Should authentication be accepted at step 507 or if additional authentication is not needed at step 506, access to electronic device is permitted at step 508.

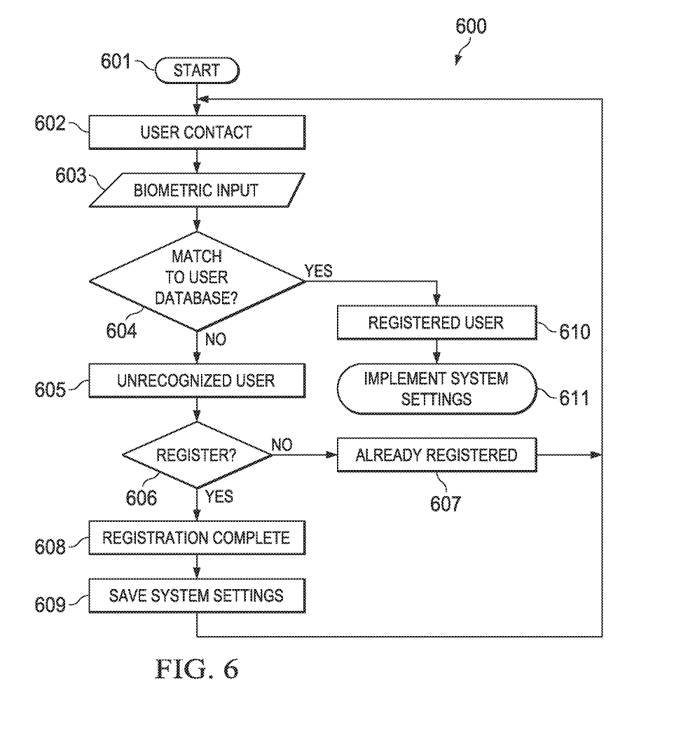

FIG. 6 is a flow chart of an illustrative process for authenticating the user of an electronic device in accordance with one embodiment of the invention. In FIG. 6, a multiple user device may be a public device with plurality of potential users, some of whom may not have used said specific electronic device before. In one embodiment, of which FIG. 6 is illustrative, the database of biometric data for each user may accompany user specific settings and/or data and may be stored on remote or cloud based storage. In such an embodiment a user would have a remote master copy of their settings or data where changes made on any eligible device would result in changes to the master copy and thus be available on other devices simultaneously. At step 602, a user interaction similar to step 402 or step 502, results in an interaction from which a biometric input may be gathered at step 603. The electronic device matches the biometrics input to an entry in the user database at step 604 to authenticate the user. If the user is authenticated, they are established as a registered user at step 610 and the electronic device loads data and implements system settings at step 611 that may be stored locally or remotely that are associated with the authenticated user. If there is no match to the database at step 604, an unrecognized user is established at step 605.

Additional authentication measures may be requested for initial or recurring authentication. Should a user not be recognized by the user database at step 604, the unrecognized user 605 may be prompted to register at step 606 as a new user to begin their local or remote account storing their biometric data along with settings and other data to which they may desire remote access. If the user is already registered as determined at step 606, they are identified as a registered user at step 607 and they may begin authentication again at 602. If the user chooses to create a new account, they would register the chosen data and upon completion at step 608, the system settings would be saved at step 609 and the device would return user interactions at step 602 for authentication.

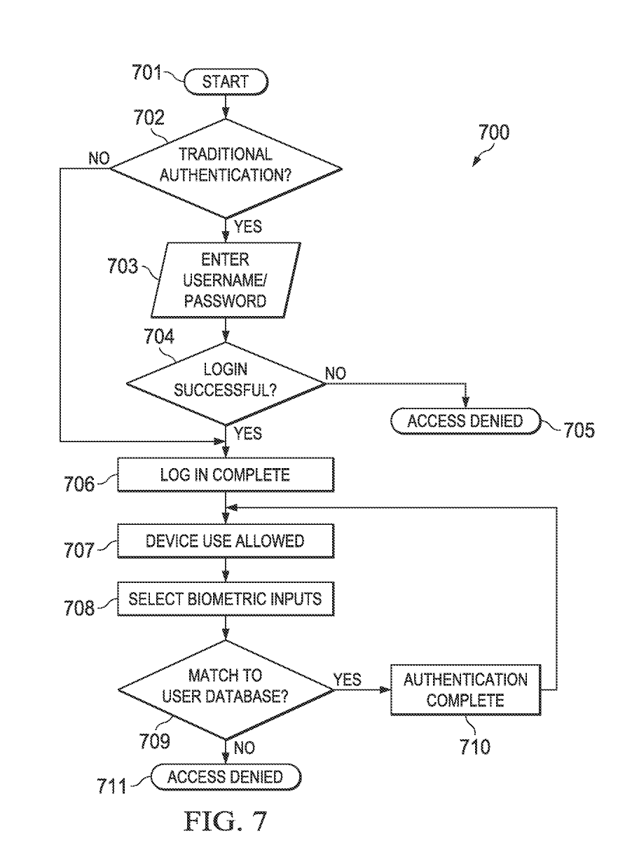

FIG. 7 is a flow chart of an illustrative process for authenticating the user of an electronic device in accordance with another embodiment of the invention. In this illustrative flow chart, following user interaction with a public or multiple user device that results in authentication, the device performs authentication on a recurring basis to continually verify the user and this authenticity. With a public device, a user may begin use through a traditional authentication procedure at step 702, such as a username and password combination. If traditional authentication is required, a username and password is entered at step 703, and the login credentials are verified at step 704. If at inquiry step 704 authentication is not correct, within predetermined parameters for multiple attempts, access is denied at step 705. Should authentication be correct or traditional authentication at step 702 is not required, the initial log in is complete at step 706 and device use is allowed at step 707. With device interaction or inputs, biometric inputs are gathered and the inputs, or a portion thereof, are selected at step 708 for use based authentication. The inputs are matched to the database at step 709 and if correct, the authentication is complete and continued use is permitted at step 710. Device control returns to step 707. If a match is not successful at step 709, access is denied at step 711 and if use is desired thereafter device would go to step 701. In some embodiments, as is present with traditional authentication measures, continuous incorrect authentication attempts may result in a locked account or prevent additional attempts for a predetermined period of time. These results may occur at step 705 or step 711 in one embodiment or in others at single instances of one or the other or a plurality thereof. If a user becomes locked out at step 711 given predetermined parameters regarding rejected authentications, in one embodiment, the changes made to electronic device and its data are tracked by predetermined sessions. Upon completion of step 706 with use allowed at 707, the user has the option to review, save, or discard the changes made during a previous session.

In some embodiments, proximate communication and user identification may be used as a method of differentiation between a plurality of electronic devices. System may use distinct biometric interaction, proximity based identification, or any suitable biometric authentication system to determine and notify a user of their ownership of said device or lack thereof. For example, if two identical or similar devices are in sufficient proximity, system may determine there is a potential for mixup of devices. When the owner of a device touches the device, system may execute personalized output of a noise, screen display, or vibration pattern. If electronic device is not that of the user, system may not generate any output in some embodiments.

In other embodiments, system may generate output only if electronic device is not that of the user. For instance, if a user picks up the wrong device off a table where a similar device was proximate, this device may generate an audible sound, screen display, or vibration pattern indicating such.

In other embodiments, such a system may be of use in device security where other criteria may be of use in determining the probability of a mix up or potential theft. Such criteria may include movement or lack thereof for certain intervals, device covers or other alterations regarding physical appearance, or environmental variables.

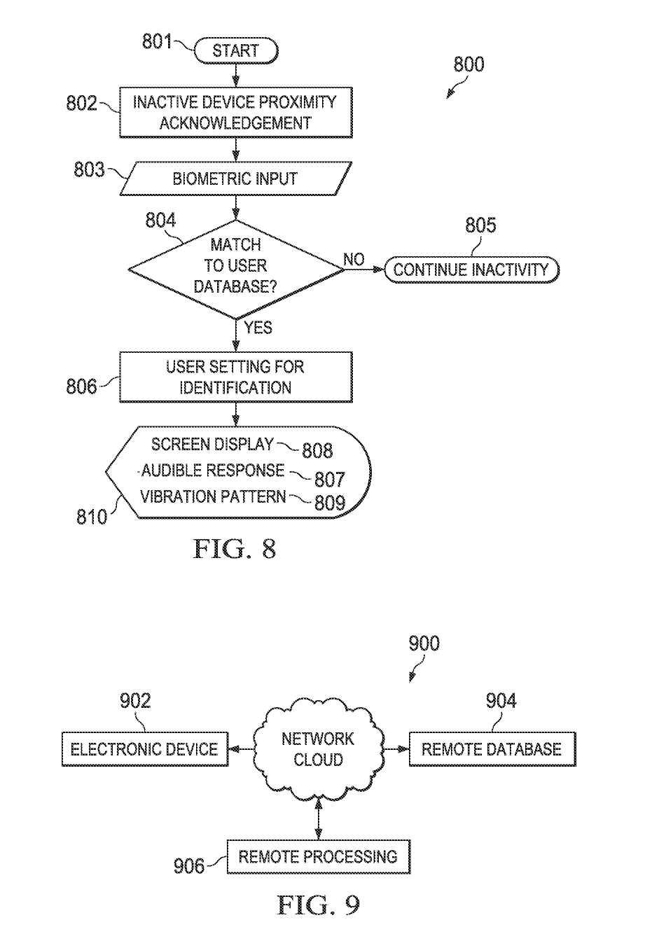

FIG. 8 is a flow chart of an illustrative process for authenticating the user of an electronic device in accordance with one embodiment of the invention. In a specific embodiment shown by the illustrative flow chart, autonomous authentication may be used for device differentiation between devices of the same or similar appearance. Once within predetermined proximity of a similar or identical device, the device would acknowledge said proximity with the other device at step 802. The device may gather a biometric input at step 803 during device interaction or user proximity and match at step 804 biometric input to the user database. If the biometric input is not authenticated at step 804, the device would continue inactivity at step 805. In the case that biometric input 803 is authenticated at step 804, a predetermined setting for identification of user ownership of said device is established at step 806 and would prompt an identifying output at step 810. Such outputs could include a screen display 808, audible response 807, vibration pattern 809, or plurality thereof. In another embodiment, the inquiry at step 804 could be reversed such that proximate or the device interacted with is not that of the user. In an example of such an interaction may a predetermined phrase spoken by a user, where device would recognize vocal patterns and or the spoken phrase and generate output in accordance with 806-810 to identify itself to the user. In an alternate example embodiment, if device does not recognize a touch input when picked up, device may generate predetermined output alerted the device possessor that said device does not belong to them with output in accordance with 806-810.

Referring now to FIG. 9, in some embodiments, remote storage may function as storage for a cloud-based device, or a remote copy of electronic device, wherein user data and settings for a device 902 are stored remotely at remote database 904 and device 902 may function as local hardware used for access and manipulation thereof. Without a communications connection to a server on which the user data is stored, a cloud-based device in some embodiments, may lack local access to portions of user data or the ability to perform certain functions. Some embodiments result in electronic device 902 being unusable without a data connection or, in others, a version of the remote data may be cached locally and available without a communications connection. In some embodiments, such an electronic device may implement an authentication system to provide access to remote content, data and settings.

In other embodiments, a device utilizing authentication system for continuous authentication and re-authentication may use remote processing on a remote processor 906 to identify a user and either continue allowing remote access in the case of the same user, or automatically implement settings and allow access to the data of a new user. In another embodiment, remote storage and remote processing occur at the same facility that may also store user settings, biometrics, and data. For example, a public cloud-based device 902 may store no data beyond necessary operating systems or applications and user interaction with such a device results in remote authentication, identification and data access. Once identified, remote storage database 904 may upload data to device for local storage or permit virtual access and manipulation of remote data. In some embodiments, remote data may be updated by changes in local data that may be reflected on the user's principal device or on other devices on which the user authenticates.

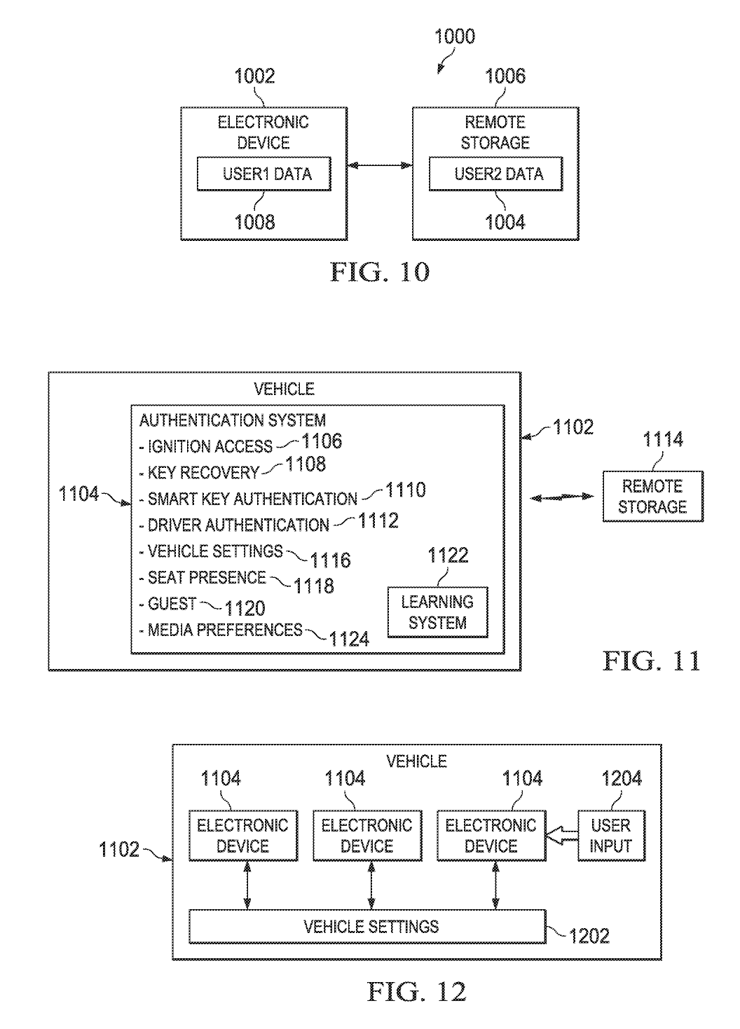

Referring now to FIG. 10, in other embodiments a device 1002 that is not cloud-based, may allow remote access to another user's data and settings 1004 at remote storage 1006 following identification and authentication of the second user at the electronic device 1002. The data 1004 of the second user may be downloaded, or accessed and manipulated remotely on electronic device 1002; while maintaining the local storage of the data 1008 of the original user, the electronic device may not permit local data access. For example, an electronic device 1002 in use by the first user, its owner, is lent to a second user whose biometrics are measured by electronic device. After authentication of a second user, whose data and settings 1004 are not those of the current (first) user, electronic device 1002 revokes access to current data 1008 and loads data and settings 1004 of the second, now the current, user. New data and settings may be virtual and manipulate remote data or downloaded locally with manipulation later reflected in remote storage. For example, if a second user has possession of electronic device of another user, interaction with the device of the second user may permit he or she to make a phone call from the contact list of the second user without access to such data of the first user.

In a general embodiment of FIG. 9 and FIG. 10, the electronic device communicates with remote storage, which may include remote processing of authentication protocols, may permit an alternate electronic device to function as if it were the device of another user. Remote storage may also allow for changes made to data and settings on an alternate device to be reflected on the original device and vice versa.

Referring now to FIG. 11, a specific embodiment of the electronic device may be implemented in a vehicle 1102 where authentication system 1104 may allow access to, or the ability to start the ignition 1106. Implementation in some embodiments may be used as a recovery method 1108 when a user has locked keys in a vehicle or as a theft prevention measure. In other embodiments, electronic device may be an additional layer of authentication 1110 for vehicle access along with a key or smart-key. Other embodiments may implement authentication system as the sole driver authentication measure 1112, whereby a car key is not necessary for vehicle access or use. Implementation of the authentication system 1104 in a vehicle 1102 may include embedded electronic device as a separate system or integrate electronic device into systems already in place. In some embodiments, the authentication system 1104 may be embedded in aspects of a vehicle 1102 where user touch or interaction is common such a door handle, glass surface, steering wheel, gear shift, or center console area.

In an embodiment that includes remote storage 1114, access to a vehicle 1102 as well as implementation of vehicle settings 1116 may occur via authentication system. For example, contact with biometrics on a steering wheel could identify different drivers and implement their desired settings such as seat height, angle, lumbar support, entertainment center presets, mirror presets, steering wheel pitch, driving mode, window tint, climate control, or other customizable vehicle settings.

In another embodiment, may be implemented in an electronic device carried into or installed in the vehicle and may function as a proxy for direct authentication for a vehicle, be the system by which vehicle authentication occurs, or function as an additional layer for vehicle authentication. For instance, a seat presence function 1118 controls communication between a specific seat in a vehicle and the authentication system 1104 may implement relevant settings. In another embodiment, a vehicle owner may permit another person to use their vehicle after authentication that the owner occupies passenger seat. In other embodiments, the owner of a vehicle may implement limitations for a guest or other allowed driver in a guest function 1120. For example, a parent may limit the access of a child regarding vehicle performance such as a maximum speed.

In other embodiments, automated implementation of settings could be made available across multiple vehicles and in different vehicle classes with preferences stored externally at remote storage 1114 and received by the respective vehicle 1102. In some embodiments, a learning system 1122 may be included in remote authentication processing and remote storage of settings. This learning system 1122 may adjust stored settings to be implemented in a new vehicle when stored settings are not directly implementable in a new vehicle. For instance, a user may own a compact car where authentication and settings are stored remotely. When this user rents a vehicle of a different class, perhaps a truck, the system may compare the cabin and interior of the vehicles and make adjustments to settings that are sent to the new vehicle. System may also may track changes over time and adjust stored measures accordingly. In some embodiments, changes to settings in other vehicles may also be stored such that data for a plurality of vehicles may be associated with a user. Multiple settings for users may be used by the system to better predict desired settings.

In other embodiments, media-related preferences 1124 may be sent to different vehicles and the remote system may adjust the settings depending on location of the vehicle. For example, a user may have radio presets set for jazz and talk radio stations in their area. Remote system may implement new local stations in that vehicle, or a new vehicle, when a user is in new location that may not offer the same stations. System may find similar stations for user and store selections and changes for the new area.

Referring now to FIG. 12, in other embodiments, an electronic device/authentication system 1104 or plurality thereof may communicate to jointly determine vehicle settings 1202 and their implementations. These vehicle settings 1202 may be subject to, constrained or altered by user input 1204. For instance a vehicle 1102 with more than one row of seating may distribute legroom evenly, relative to size, or in another predetermined fashion between occupants seated in front or behind one another superseding default vehicle settings 1202 which would be implemented in absence thereof. In other embodiments, electronic device/authentication system 1104 may optimize allocated space in general in vehicles 1102 that allow seat movement beyond forward and back directions. System or electronic devices 1104 may compare multiple preferences and implement settings 1202 considered more egalitarian than would be implemented in a singular fashion. In other embodiments, it may be determined that the seating arrangement of occupants is not optimal and rearrangement would result in a more comfortable outcome.

In some embodiments, recommendations may be generated when alternate settings 1202 result in a more favorable, egalitarian, or comfortable overall result. Said recommendations may be subject to predetermined parameters, such as, which passengers could be considered drivers, which passengers would prefer a certain seat, or preferences regarding proximate passengers. In other embodiments, recommendations, compromises, or suggestions may be generated and implemented automatically or sent to the passengers, or a sub-section thereof, for manual implementation. For example, if a group of passengers rented a new vehicle while on vacation, not every preference of each passenger and driver may be able to be reconciled and implemented without conflict. System 1104 may suggest that two passengers switch seats so that each person would have adequate leg room. System 1104 may recommend the least objectionable media preferences to a group, display commonalities, or make suggestions regarding potentially acceptable preferences. Recommendations thereof may be routed through system or electronic device embedded in a vehicle or take place via personal electronic devices 1104 that may communicate with each other directly or through a remote system.

In other embodiments, system and data may make recommendations on car rentals or purchases regarding a person or relevant group thereof. For instance, it may be determined that the current vehicle selection is not optimal based on any given occupancy arrangement for the group in question.

It is apparent that, although the invention has been described in connection with the preferred embodiments, it is contemplated that those skilled in the art may make changes to the preferred embodiments without departing from the scope of the invention as described in following claims. The appended claims are not necessarily limited to the specificities above, rather they are disclosed as a form of implementing the following claims.

What is claimed is:

1. A method for authentication a user of an electronic device without requiring active input from the user, comprising:
receiving a plurality of user inputs to the electronic device that are unrelated to an active authentication action of the user of the electronic device;
extracting from the plurality of user inputs, biometric data identifying the user; and
authenticating the user using the extracted biometric data.

2. The method of claim 1, wherein the step of extracting further comprises extracting a single biometric data point identifying the user.

3. The method of claim 1, wherein the step of extracting further comprises the step of extracting randomly selected biometric data points.

4. The method of claim 1, wherein the step of extracting further comprises the step of extracting biometric data points according to a predetermined algorithm.

5. The method of claim 1, wherein the step of authenticating further comprises the step of continuously authenticating the user each time the extracted biometric data is extracted from the plurality of user inputs.

6. The method of claim 1, wherein the step of authenticating further comprises the step of continuously authenticating the user via sub-set of the extracted biometric data selected in a predetermined method.

7. The method of claim 1, wherein the step of authenticating further comprises:
transmitting the biometric data to a remote location separate from a location of the electronic device;
authenticating the user using the extracted biometric data at the remote location.

8. The method of claim 1, wherein the user comprises one of a plurality of users of the electronic device.

9. The method of claim 8, further comprising updating the electronic device with user data associated with the user of the plurality of users responsive to the authentication of the user.

10. The method of claim 1, further including the step of configuring the electronic device as a cloud based device with user data associated with the user responsive to authentication of the user.

11. The method of claim 1, wherein the electronic device is implemented within a vehicle.

12. The method of claim 11 further comprising the step of configuring settings within the vehicle responsive to authentication of the user.

13. The method of claim 11, further comprises the steps of:
authenticating multiple users within the vehicle; and
configuring settings within the vehicle responsive to settings associated with the multiple authenticated users.

14. The method of claim 1, further including the step of providing an output from the electronic device uniquely associated with the authenticated user.

15. An electronic device for authentication a user without requiring active input from the user, comprising:
at least one user interface for receiving a plurality of user inputs to the electronic device that are unrelated to an active authentication action of the user of the electronic device;
at least one biometric sensor for extracting from the plurality of user inputs, biometric data identifying the user; and
a processor for authenticating the user responsive to the extracted biometric data.

16. The electronic device of claim 15, wherein the at least one biometric sensor extracts at least a single biometric data point identifying the user.

17. The electronic device of claim 15, wherein the at least one biometric sensor extracts randomly selected biometric data points.

18. The electronic device of claim 15, wherein the at least one biometric sensor extracts biometric data points according to a predetermined algorithm.

19. The electronic device of claim 15, wherein the processor further continuously authenticates the user each time the extracted biometric data is extracted from the plurality of user inputs.

20. The electronic device of claim 15, wherein the processor further transmits the biometric data to a remote location separate from a location of the electronic device and authenticates the user using the extracted biometric data at the remote location.

21. The electronic device of claim 15, wherein the user comprise one of a plurality of users of the electronic device.

22. The electronic device of claim 21, wherein the processor updates the electronic device with user data associated with the user of the plurality of users responsive to the authentication of the user.

23. The electronic device of claim 15, wherein the processor further configures the electronic device as a cloud based device with user data associated with the user responsive to authentication of the user.

24. The electronic device of claim 15, wherein the electronic device is implemented within a vehicle.

25. The electronic device of claim 24, wherein the processor further configures settings within the vehicle responsive to authentication of the user.

26. The electronic device of claim 25, wherein the processor is further configured to authenticate multiple users within the vehicle and configure settings within the vehicle responsive to settings associated with the multiple authenticated users.

27. The electronic device of claim 15, wherein the processor is further configured to provide an output from the electronic device uniquely associated with the authenticated user.
